(19) United States
(12) Patent Application Publication
(10) Pub. No.: US 2019/0390591 A1
(43) Pub. Date: Dec. 26, 2019

(54) PISTON FOR INTERNAL COMBUSTION ENGINE AND METHOD OF MANUFACTURING SAME

(71) Applicant: Hitachi Automotive Systems, Ltd., Hitachinaka-shi, Ibaraki (JP)

(72) Inventors: Yoshihiro SUKEGAWA, Tokyo (JP); Norikazu TAKAHASHI, Hitachinaka-shi (JP); Ittou SUGIMOTO, Tokyo (JP)

(73) Assignee: Hitachi Automotive Systems, Ltd., Hitachinaka-shi, Ibaraki (JP)

(21) Appl. No.: 16/484,043

(22) PCT Filed: Feb. 2, 2018
(86) PCT No.: PCT/JP2018/003614

§ 371 Date: Aug. 6, 2019

(30) Foreign Application Priority Data
Feb. 9, 2017 (JP) 2017-022274

(51) Int. Cl. F02B 23/10; F02F 3/12; F02B 23/06

(52) U.S. Cl. CPC F02B 23/10; F02F 3/12; F05C 2201/021; F01L 2101/02; F02F 2200/00; F02B 23/0639

(57) ABSTRACT

Provided is a piston for an internal combustion engine, the piston enabling both an improvement in heat efficiency and a reduction in emissions, and enabling the prevention of overheating of the piston to prevent the occurrence of knocking, pre-ignition, and a drop in air filling efficiency. This piston (100a) for an internal combustion engine constitutes a portion of a combustion chamber (9) of an internal combustion engine (200) and includes a substrate (103), a first film (101) provided on a section of the top surface of the substrate (103) contacting the combustion chamber (9), and a second film (102) provided on another section of the top surface. The piston for the internal combustion engine is characterized in that: the first film (101) has a lower heat conductivity and heat capacity than the substrate (103), and the second film (102) has a lower heat conductivity than the substrate (103) and a higher heat capacity than the first film (101).

### TECHNICAL FIELD

The present invention relates to a piston for an internal combustion engine and a method of manufacturing the same.

### BACKGROUND ART

In an internal combustion engine such as a gasoline engine, a part of heat generated by combustion passes through a wall surface from a combustion chamber and is discharged to outside, thus resulting in a loss. In order to improve heat efficiency of the internal combustion engine, it is necessary to reduce a cooling loss thereof. Therefore, there has been a method (so-called temperature swing heat shielding method) of reducing a heat flux on a piston surface in which a film having a low heat conductivity and a low heat capacity is formed on the piston surface that occupies a relatively large area of the wall surface of the combustion chamber, so that heat insulation of the combustion chamber is improved, and a temperature of the piston surface is made to follow a temperature of in-cylinder combustion gas with a small time delay.

On the other hand, when fuel droplets adhere to the piston surface having a low heat capacity as described above, a piston temperature of an adhered portion is lowered, and vaporization of fuel is deteriorated. This causes an increase in emissions (harmful substances in exhaust gas) such as PM (soot particles) and HC (unburned hydrocarbons) particularly during a cold start of the engine.

In order to improve heat efficiency (reduction of a cooling loss) while keeping emissions low, for example, PTL 1 discloses a piston that constitutes an internal combustion engine, in which an anodic oxide coating having a low heat conductivity and a low heat capacity is formed on a top surface of the piston, and a metal coating having a heat capacity relatively higher than that of the anodic oxide coating is formed on a surface of a fuel injection region on the anodic oxide coating. According to the configuration of PTL 1, it is described that the piston contributes to an engine performance of high gasoline mileage and high efficiency during steady traveling of a vehicle, and contributes to a rapid temperature rise in the top surface of the piston and in a combustion chamber during a start of the vehicle to prevent generation of HC, PM and the like.

### PRIOR ART LITERATURE

### Patent Literature

PTL 1: JP-A-2013-67823

### SUMMARY OF INVENTION

### Technical Problem

However, with the configuration of PTL 1 described above, it is difficult to improve the heat efficiency while emissions is kept low, and to prevent the piston from being excessively high so as to prevent occurrence of knocking and pre-ignition and decrease in air filling efficiency.

In view of the above, an object of the invention is to provide a piston for an internal combustion engine in which heat efficiency can be improved while emissions is kept low, and the temperature of the piston can be prevented from being excessively high so that the occurrence of knocking and pre-ignition and decrease in air filling efficiency is prevented, and to provide a method of manufacturing the piston for the internal combustion engine.

### Solution to Problem

In order to solve the above problems, the invention provides a piston that constitutes a part of a combustion chamber of an internal combustion engine. The piston includes a base material, and a first film and a second film that are provided on a top surface of the base material in contact with the combustion chamber. The first film has a heat conductivity and a heat capacity smaller than those of the base material, and the second film has a heat conductivity smaller than that of the base material, and a heat capacity greater than that of the first film. The second film is provided on the top surface of the base material at a portion where the first film is not formed.

The invention provides a method of manufacturing a piston for an internal combustion engine, the piston constituting a part of an inner wall surface of a combustion chamber of the internal combustion engine, the method of manufacturing the piston for the internal combustion engine including: a step of preparing a base material; a step of preparing a first film having a heat conductivity and a heat capacity smaller than those of the base material, and a second film having a heat conductivity smaller than that of the base material and a heat capacity greater than that of the first film; a step of preparing an insert material having a melting point lower than that of the base material, that of the first film, and that of the second film; a step of disposing the first film and the second film on a surface of the base material with the insert material being sandwiched; and a bonding step of heating the insert material to bond the first film and the second film to the base material.

The more specific configuration of the invention is set forth in the claims.

### Advantageous Effect

According to the invention, it is possible to provide a piston for an internal combustion engine in which heat efficiency can be improved while emissions is kept low, and the temperature of the piston can be prevented from being excessively high so that the occurrence of knocking and pre-ignition and decrease in air filling efficiency is prevented, and to provide a method of manufacturing the piston for the internal combustion engine.

Other problems, configurations, and effects will be apparent from the following description of the embodiments.

### BRIEF DESCRIPTION OF DRAWINGS

FIG. 1 is a longitudinal sectional view illustrating a first example of an internal combustion engine including a piston for an internal combustion engine according to the invention.

FIG. 2 is a plan view of the piston of FIG. 1 when viewed from a combustion chamber side.

FIG. 3 is a graph showing heat conductivities and heat capacities (volumetric specific heats) of a base material 103, a first film 101, and a second film 102 that constitute the piston according to the invention.

FIG. 4 is a graph showing a relationship between a surface temperature of the piston and a crank angle during operation of the internal combustion engine including the piston according to the invention.

FIG. 5 is a view illustrating a state in which fuel is injected from a fuel injection valve 5 into a combustion chamber in FIG. 1.

FIG. 6 is a plan view of the piston of FIG. 5 when viewed from the combustion chamber side.

FIG. 7 is a longitudinal sectional view illustrating a second example of an internal combustion engine including a piston according to the invention.

FIG. 8 is a plan view of the piston of FIG. 7 when viewed from the combustion chamber side.

FIG. 9 is a longitudinal sectional view illustrating a third example of an internal combustion engine including a piston according to the invention.

FIG. 10 is a longitudinal sectional view illustrating a fourth example of an internal combustion engine including a piston for an internal combustion engine according to the invention.

FIG. 11 is a plan view of the piston of FIG. 10 when viewed from the combustion chamber side.

FIG. 12 is a longitudinal sectional view illustrating a fifth example of an internal combustion engine including a piston according to the invention.

FIG. 13 is a graph showing a thickness of a liquid film of FIG. 12.

FIG. 14 is a graph showing a relationship between a heat resistance of the second film and the thickness of the liquid film.

FIG. 15 is a graph showing a relationship between the heat resistance of the second film and a distance between the fuel injection valve and the second film.

FIG. 16 is a longitudinal sectional view illustrating a sixth example of an internal combustion engine including a piston according to the invention.

FIG. 17 is a longitudinal sectional view illustrating a seventh example of an internal combustion engine including a piston according to the invention.

FIG. 18 is a longitudinal sectional view illustrating an eighth example of an internal combustion engine including a piston according to the invention.

FIG. 19 is a longitudinal sectional view illustrating a ninth example of an internal combustion engine including a piston according to the invention.

FIG. 20 is a longitudinal sectional view illustrating a tenth example of an internal combustion engine including a piston according to the invention.

FIG. 21 is a schematic view illustrating a cross section of a piston for an internal combustion engine of related art.

FIG. 22 is a graph showing surface temperature changes of an anodic oxide coating 101′ and a metal coating 102′ in one cycle of the engine including the piston of FIG. 21.

FIG. 23 is a schematic view illustrating a cross section of the piston for the internal combustion engine according to the invention.

FIG. 24 is a graph showing surface temperature changes of the first film 101 and the second film 102 in one cycle of the engine including the piston of FIG. 23.

FIG. 25 is a sectional view schematically illustrating a surface layer (the first film and the second film).

FIG. 26 is an enlarged schematic view of a metal particle that constitutes a metal phase 136 of FIG. 25.

FIG. 27 is a view schematically illustrating the first film and the second film obtained by forming sintered bodies.

FIG. 28 is a sectional view and a plan view of an example of the base material.

FIG. 29 is a sectional view illustrating a state in which base sintered bodies are disposed on a surface of the base material.

FIG. 30 is a schematic view illustrating an apparatus for bonding the base sintered bodies to the base material in FIG. 29.

FIG. 31 is a sectional view schematically illustrating forming (machining) of a top surface of the piston.

FIG. 32 is a sectional view schematically illustrating another example of the base material and the base sintered bodies.

### DESCRIPTION OF EMBODIMENTS

Hereinafter, embodiments of the invention will be described in detail with reference to the accompanying drawings.

### 1. Basic Concept of Invention

FIG. 21 is a schematic view illustrating a cross section of a piston for an internal combustion engine of related art. As illustrated in FIG. 21, in a piston 100′ of the related art (PTL 1), an anodic oxide coating 101′ having a low heat conductivity and a low heat capacity is provided on a surface of a base material 103′, and a metal coating 102′ having a heat capacity relatively higher than that of the anodic oxide coating 101′ is provided on a part (fuel injection region) of a surface of the anodic oxide coating 101′. That is, the anodic oxide coating 101′ and the metal coating 102′ are laminated on the surface of the base material 103′.

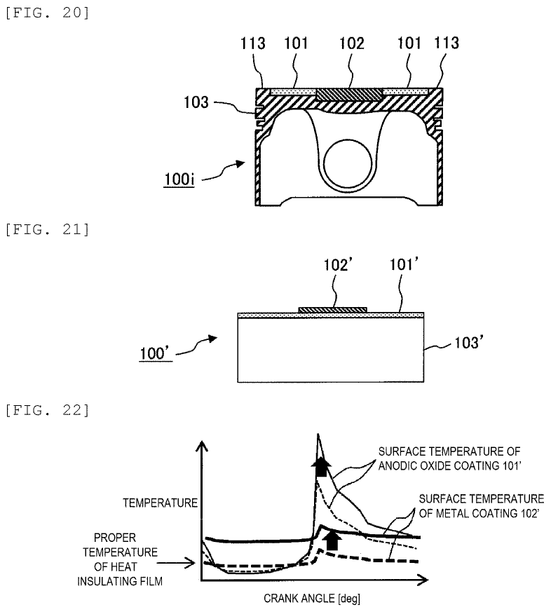

FIG. 22 is a graph showing surface temperature changes of the anodic oxide coating 101′ and the metal coating 102′ in one cycle of the engine including the piston of FIG. 21. FIG. 22 shows surface temperatures of the anodic oxide coating 101′ and the metal coating 102′ when the heat conductivity of the anodic oxide coating 101 is further reduced with respect to base conditions respectively indicated by a dotted line and a solid line. As shown in FIG. 22, since the metal coating 102′ is formed on the surface of the anodic oxide coating 101′ in the related art, a heat resistance R from a surface of the metal coating 102′ (a surface on a combustion chamber side) to the base material 103′ is a sum of a heat resistance R_{102′} of the metal coating 102′ and a heat resistance R_{101′} of the anodic oxide coating 101′.

In order to enhance an effect of reducing a cooling loss by a temperature swing heat shielding method, it is desirable to reduce the heat conductivity of the anodic oxide coating 101′ as much as possible to increase a width of a surface temperature change of the anodic oxide coating 101′ in a cycle. However, when the heat conductivity of the anodic oxide coating 101′ decreases (the heat resistance R_{101′} of the anodic oxide coating 101′ increases), the heat resistance R from the surface of the metal coating 102′ to the base material 103′ increases, and therefore, a surface temperature of the metal coating 102′ also increases. The metal coating 102′ is maintained at a high surface temperature from an intermediate stage of an intake stroke to an intermediate stage of a compression stroke, thereby promoting vaporization of a fuel liquid film. However, when the temperature is excessively increased, deterioration of knocking or pre-ignition, and decrease in air filling efficiency and the like are caused.

Therefore, in the related art, when the heat conductivity of the anodic oxide coating 101′ is reduced in order to reduce a cooling loss, there is a risk of repercussions such as deterioration of knocking or pre-ignition, and decrease in air filling efficiency and the like. In order to prevent this, a method of reducing a film thickness of the metal coating 102′ is considered, but durability and the heat capacity of the metal coating 102′ may be insufficient due to the reduction in the film thickness.

Therefore, in the configuration of the related art, it is difficult to further reduce a cooling loss and to prevent occurrence of knocking and pre-ignition and decrease in air filling efficiency while sufficiently ensuring the durability and the heat capacity of the metal coating 102′.

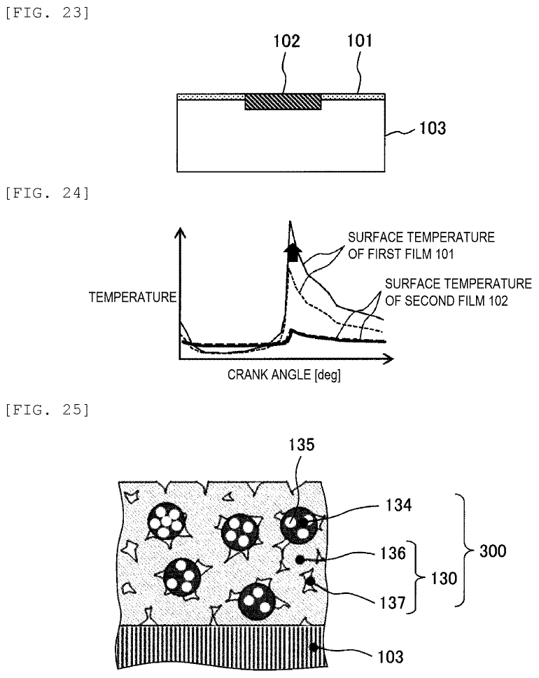

As a result of intensive studies to solve the above problems, the inventors have found the following configurations and have completed the invention. FIG. 23 is a schematic view illustrating a cross section of a piston for an internal combustion engine according to the invention. As illustrated in FIG. 23, in the piston for the internal combustion engine according to the invention (hereinafter, simply referred to as “piston”), a first film 101 having a low heat capacity and a low heat conductivity is formed on a surface of a base material 103 (a top surface of the piston), and a second film 102 having a higher heat capacity and a lower heat conductivity is formed on the surface of the base material 103 at a portion other than the portion where the first film 101 is provided.

FIG. 24 is a graph showing surface temperature changes of the first film 101 and the second film 102 in one cycle of the engine including the piston of FIG. 23. FIG. 24 shows surface temperatures of the first film 101 and the second film 102 when the heat conductivity of the first film 101 is further reduced with respect to base conditions respectively indicated by a dotted line and a solid line.

In the invention, since the first film 101 and the second film 102 are formed in parallel on the base material 103 (since the first film 101 and the second film 102 are not laminated), a heat resistance R₁₀₂ from a surface of the second film 102 (a surface on a combustion chamber side) to the base material 103 is not affected by a heat resistance R₁₀₁ of the first film 101. Therefore, even when the heat conductivity of the first film 101 is reduced to further enhance an effect of reducing a cooling loss by the temperature swing heat shielding method, a surface temperature of the second film 102 does not become excessively high, knocking and pre-ignition do not occur, and air filling efficiency does not decrease.

Since the heat resistance R₁₀₂ of the second film 102 can be controlled independently of the heat resistance R₁₀₁ of the first film 101, the configuration of the heat resistance R₁₀₂ of the second film 102 can be changed according to a thickness of the fuel liquid film, for example, the heat resistance R₁₀₂ of the second film 102 of a portion where a relatively thick fuel liquid film is formed may be increased or the like.

Further, in the configuration of the related art, since the films having different heat characteristics are stacked, there is a concern that manufacturing man-hours is increased or adhesion strength of the films is lowered. On the other hand, since the first film 101 and the second film 102 are not laminated in the invention, such a problem can be avoided.

A structure of the piston for the internal combustion engine according to the invention will be described in detail below.

### 2. Piston for Internal Combustion Engine

(2.1) Structure of Piston

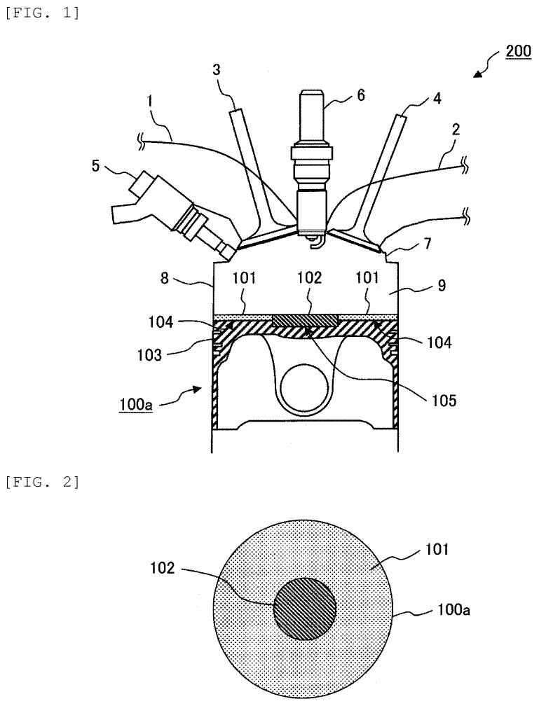

FIG. 1 is a longitudinal sectional view illustrating a first example of an internal combustion engine including the piston for the internal combustion engine according to the invention. FIG. 2 is a plan view of the piston of FIG. 1 when viewed from the combustion chamber side. An internal combustion engine 200 illustrated in FIG. 1 is a spark-ignition four-cycle gasoline engine. A combustion chamber 9 includes an engine head 7, a cylinder 8, a piston 100a, an intake valve 3, and an exhaust valve 4. A surface of the piston 100a constitutes a part of the combustion chamber 9. A fuel injection valve 5 is provided on the engine head 7. An injection nozzle of the fuel injection valve 5 penetrates the combustion chamber 9 to constitute a so-called in-cylinder direct injection engine. Further, an intake port 1 for taking air into the combustion chamber 9, an exhaust port 2 for discharging combustion gas of the combustion chamber 9, and an ignition plug 6 for igniting a fuel-air mixture are provided on the engine head 7.

The piston 100a includes the base material 103, and the first film (heat shielding film) 101 and the second film (heat insulating film) 102 that are provided on a surface (top surface) of the base material 103 in contact with the combustion chamber. The first film 101 is provided on a portion of the top surface of the base material 103, and the second film 102 is provided on another portion of the top surface of the base material 103. That is, the first film 101 and the second film 102 are disposed in parallel so as not to overlap each other on the top surface the piston. That is, the first film 101 and the second film 102 are disposed in parallel when the piston 100a is viewed from an upper surface (a surface constituting the combustion chamber). The base material 103 and the first film 101 are bonded by the entire or a large portion of a bottom surface 104 of the first film 101 and a part of the top surface of the base material 103. Similarly, the base material 103 and the second film 102 are bonded by the entire or a large portion of a bottom surface 105 of the second film 102, another portion of the top surface of the base material 103 and the base material 103.

As illustrated in FIG. 2, in the present embodiment, the second film 102 is disposed near a center of the piston 100a, and the first film 101 is disposed around the second film 102. An area of the first film 101 on a top surface of the piston 100a is relative larger than an area of the second film 102 on the top surface of the piston 100a.

Here, the first film 101, which is also referred to as a “heat shielding film”, is a film having a function of insulating the combustion chamber from heat to enable a temperature of a piston surface to follow a gas temperature in the combustion chamber with a small time delay, and is formed of a thin plate material, a coating material or the like that has a low heat conductivity and a low heat capacity (low volumetric specific heat). Here, the “low heat conductivity” and the “low heat capacity (low volumetric specific heat)” mean that the heat conductivity and the heat capacity (volumetric specific heat) are lower than those of the base material 103. Specifically, it is desirable that the heat conductivity is 0.5 W/mK or less, the volumetric specific heat is 500 kJ/m³K or less, and a film thickness is 50 μm to 200 μm (50 μm or more and 200 μm or less). When the heat conductivity is greater than 0.5 W/mK, a heat insulation performance of the combustion chamber is not sufficient. When the volumetric specific heat is greater than 500 kJ/m³K, a performance of following the gas temperature is not sufficient. When the film thickness is less than 50 μm, the heat insulation performance is not sufficient, and when the film thickness exceeds 200 μm, heat responsiveness deteriorates.

The second film 102, which is also referred to as a “heat insulating film”, is a film having a function of vaporizing fuel that adheres to the top surface of the piston, and is formed of a thin plate material, a coating material or the like that has a low heat conductivity and a high heat capacity (high volumetric specific heat). Here, the “high heat capacity (high volumetric specific heat)” means that the heat capacity (volumetric specific heat) is higher than that of the first film 101. It is desirable that the heat conductivity is 1 to 10 W/mK, the volumetric specific heat is 1000 kJ/m³K or more, and a film thickness is 200 μm or more. When the heat conductivity is greater than 10 W/mK, the heat insulation performance of the combustion chamber is not sufficient. When the volumetric specific heat is larger than 1000 kJ/m³K, the performance of following the gas temperature is not sufficient. When the film thickness is less than 200 μm, an average temperature (average temperature over time) of the combustion chamber is too low. The configurations of the first film 101 and the second film 102, and a method of manufacturing the same will be described in detail below.

A material of the related art can be used for the base material 103. For example, aluminum alloy, iron or titanium alloy, or the like can be used. It is preferable that a heat conductivity of the material of the related art is 50 to 200 W/mK, and a volumetric specific heat thereof is 2000 to 3000 kJ/m³K.

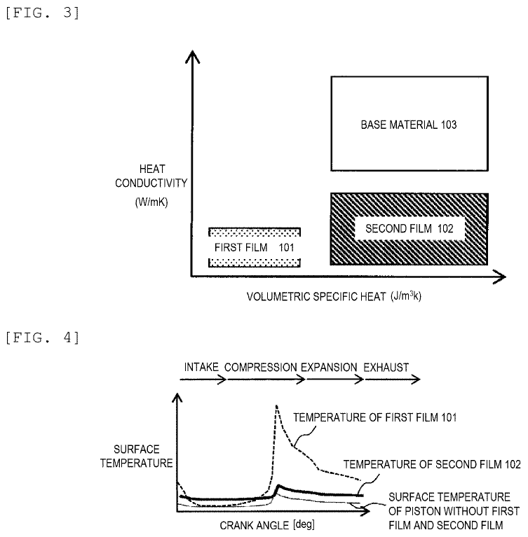

FIG. 3 is a graph showing heat conductivities and heat capacities (volumetric specific heats) of the base material 103, the first film 101, and the second film 102 that constitute the piston according to the invention. As shown in FIG. 3, the heat conductivity and the volumetric specific heat of the first film 101 are respectively smaller than the heat conductivity and the volumetric specific heat of the base material 103. The heat conductivity of the second film 102 is smaller than the heat conductivity of the base material 103. The volumetric specific heat of the second film 102 is greater than the volumetric specific heat of the first film 101. When the base material 103, the first film 101, and the second film 102 have such a relationship, the above-described effects of the invention can be obtained.

FIG. 4 is a graph showing a relationship between the temperature of the piston surface and a crank angle during operation of the internal combustion engine including the piston according to the invention. That is, FIG. 4 is a graph showing a time change in a temperature of the top surface of the piston during the operation of the internal combustion engine. More specifically, FIG. 4 shows crank angle changes with the surface temperatures of the first film 101 and the second film 102 in one cycle including an intake stroke, a compression stroke, an expansion stroke, and an exhaust stroke of the engine. As a reference, FIG. 4 also shows a temperature of a piston surface including only the base material 103 where the first film 101 and the second film 102 are not provided.

Since the first film 101 has a low heat conductivity and a low heat capacity, a surface temperature of the first film 101 can follow a gas temperature change in the combustion chamber with a small time delay and a small temperature difference. That is, from the intermediate stage of the intake stroke to the intermediate stage of the compression stroke, the in-cylinder gas temperature decreases due to introduction of fresh air into the combustion chamber, and therefore, the surface temperature of the first film 101 also decreases. Further, from a late stage of the compression stroke to the exhaust stroke, the in-cylinder gas temperature is increased by compression and combustion of gas, and therefore, the surface temperature of the first film 101 is also increased. Accordingly, since the surface temperature of the first film 101 is changed following the in-cylinder gas temperature, a heat transfer amount between the gas and a wall surface is small, and a cooling loss of the engine can be reduced. This is a heat loss reduction method referred to as a so-called temperature swing heat shielding method.

On the other hand, since the second film 102 has a low heat conductivity and a high heat capacity, the surface temperature of the second film 102 is usually higher than a surface temperature of a piston where the first film 101 and the second film 102 are not provided and hardly responds to the gas temperature change in a cycle in the combustion chamber, and a width of a surface temperature change of the second film 102 in the engine cycle is smaller than a width of a surface temperature change of the first film 101. For example, the width of the surface temperature change of the first film 101 in a cycle is about 500° C., while the width of the surface temperature change of the second film 102 in the cycle is about 50° C. As a result, from the intermediate stage of the intake stroke to the intermediate stage of the compression stroke, the surface temperature of the second film 102 is higher than the surface temperature of the first film 101. On the other hand, from the intermediate stage of the compression stroke to the intermediate stage of the intake stroke, the surface temperature of the second film 102 is lower than the surface temperature of the first film 101.

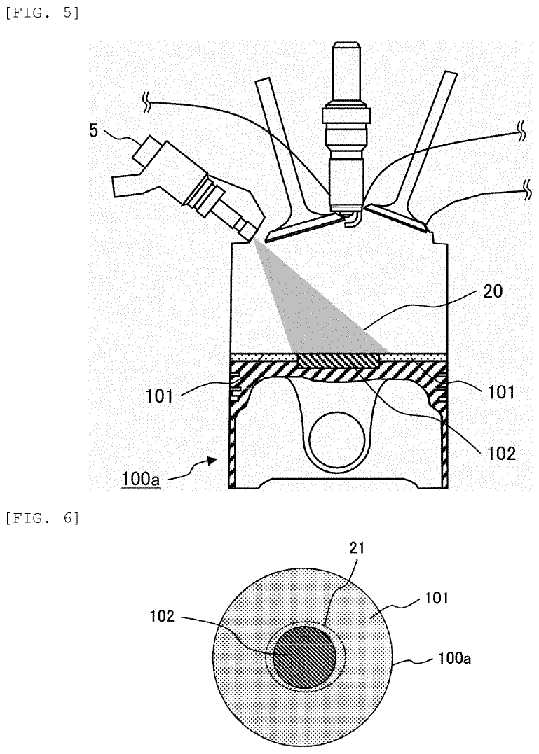

In the present embodiment, gasoline serving as fuel is injected from the fuel injection valve 5 into the combustion chamber in the intermediate stage of the intake stroke. FIG. 5 is a view illustrating a state in which the fuel is injected from the fuel injection valve 5 into the combustion chamber in FIG. 1. An injected fuel spray (spray beam) 20 travels in a direction of the piston 100a in the combustion chamber 9, and a tip end thereof collides with a surface near the center of the piston 100a. FIG. 6 is a plan view of the piston of FIG. 5 when viewed from the combustion chamber side. FIG. 6 shows a state immediately after the fuel spray 20 collides with the piston 100a. As illustrated in FIG. 6, once the fuel spray 20 collides with the piston 100a, a part of droplets adhere to the center of the top surface of the piston 100a, and a fuel liquid film 21 is mainly formed on the surface of the second film 102.

As described above, the surface temperature of the second film 102 is high from the intermediate stage of the intake stroke to the intermediate stage of the compression stroke. Since the second film 102 has a large heat capacity, even though the fuel liquid film 21 having a relatively low temperature is formed, the high temperature is maintained without following a temperature of the liquid film. Therefore, the liquid film 21 formed on the surface of the second film 102 is rapidly heated and vaporized by the heat of the second film 102.

In a piston where only the first film 101 is provided or in a piston where the first film 101 and the second film 102 are not provided, when the fuel liquid film is formed on the piston surface, since vaporization of the fuel liquid film is slow, the fuel liquid film cannot be sufficiently mixed with air, and emission of unburned hydrocarbons (HC) and soot (PM) increases. However, in the internal combustion engine according to the present embodiment, the fuel liquid film is rapidly vaporized and burned on the surface of the second film 102, so that the emission of HC and PM can be reduced. On the other hand, in the internal combustion engine according to the present embodiment, the fuel liquid film formed on the surface of the first film 101 is small, so that a cooling loss can be reduced by temperature swing heat shielding with the first film 101 while the emission of HC and PM can be kept low.

Since the surface temperature of the second film 102 hardly changes in a cycle, an effect of reducing a cooling loss is smaller than that of the temperature swing heat shielding with the first film 101. Therefore, in the internal combustion engine 200 according to the present embodiment, a surface area of the first film 101 on the combustion chamber side is greater than a surface area of the second film 102 on the combustion chamber side, and an effect of reducing a cooling loss by the temperature swing heat shielding is enhanced.

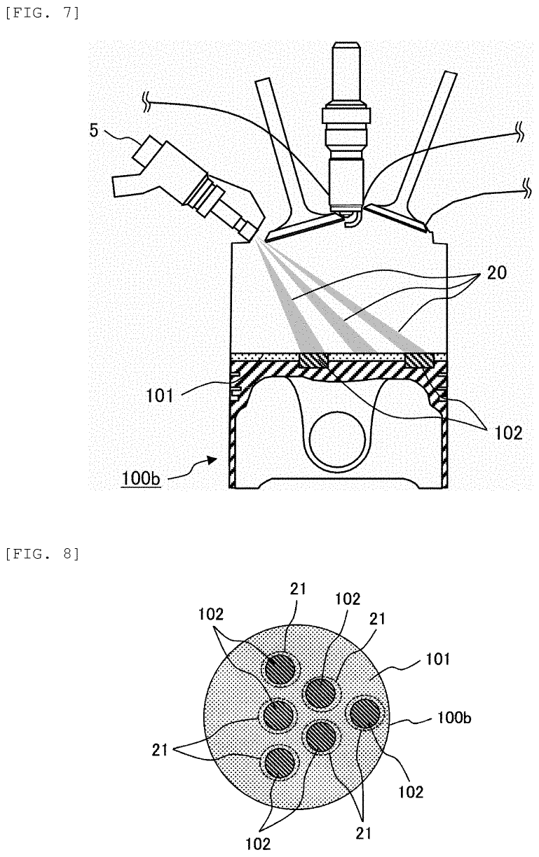

As is apparent from the above, in order to obtain an effect of reducing HC and PM of the invention, it is desirable to dispose the second film 102 on the piston surface at a location where the fuel liquid film is formed. FIG. 7 is a longitudinal sectional view illustrating a second example of an internal combustion engine including a piston according to the invention. FIG. 8 is a plan view of the piston of FIG. 7 when viewed from the combustion chamber side. In a case of the porous fuel injection valve 5 as illustrated in FIG. 7, the spray injected into the combustion chamber is formed of a plurality of fuel sprays 20 as illustrated in FIG. 7. In the case of such a porous fuel injection valve, as illustrated in FIG. 7 or 8, it is preferable that a plurality of second films 102 are disposed to match a pattern (spray positions) of the fuel liquid films 21 formed on a top surface of the piston. FIG. 8 illustrates an example in which the second films 102 are disposed on positions corresponding to the fuel liquid films 21 respectively formed by six fuel sprays 20 that are formed from the six-hole fuel injection valve.

As described above, when the plurality of second films 102 are formed on the top surface of the piston, a size of each second film 102 is determined such that a surface area of the first film 101 on the combustion chamber side is greater than a sum of surface areas of the second films 102 on the combustion chamber side.

When the plurality of second films 102 are disposed to match the pattern of the fuel liquid films 21 formed on the top surface of the piston, the fuel liquid films 21 on the top surface of the piston can be efficiently vaporized using heat of the second films 102 while an area ratio of the second films 102 to the top surface of the piston is reduced. An area ratio of the first film 101 to the piston surface can be increased by reducing the area ratio of the second films 102, so that an effect of reducing a cooling loss by the temperature swing heat shielding can be maximized.

FIG. 9 is a longitudinal sectional view illustrating a third example of an internal combustion engine including a piston according to the invention. In a piston 100c illustrated in FIG. 9, six fuel liquid films 21 formed by fuel sprays injected from the six-hole fuel injection valve are divided into three groups, and the second films 102 are disposed on positions corresponding to the fuel liquid film groups, respectively. When the second films 102 are disposed corresponding to the grouped fuel liquid films in this manner, an increase in the area of the second films 102 is prevented, the number of disposed second films 102 can be reduced, and thus simplification in a piston manufacturing process and cost reduction can be achieved.

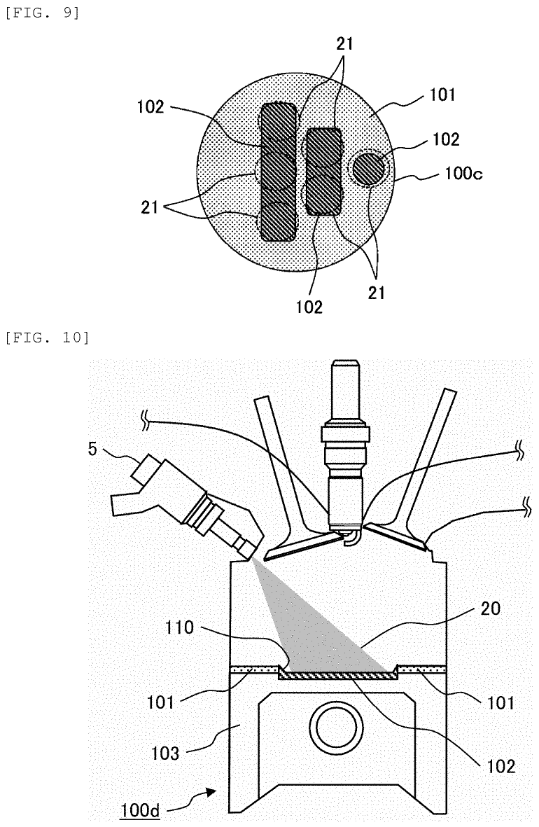

FIG. 10 is a longitudinal sectional view illustrating a fourth example of an internal combustion engine including a piston for an internal combustion engine according to the invention. FIG. 11 is a plan view of the piston of FIG. 10 when viewed from the combustion chamber side. In a direct-injection gasoline engine, ignition retardation operation is often performed immediately after a cold start of the engine for an early temperature rise of an exhaust gas catalytic converter. In order to stabilize combustion under large ignition retardation conditions, it is widely practiced to provide a cavity (recess) on a piston surface. When the cavity is provided on the piston, fuel injected into the cavity is retained in the cavity, so that a fuel-air mixture having a high fuel concentration is formed in the vicinity of the ignition plug to achieve stable combustion during the ignition retardation operation. FIG. 10 illustrates a piston 100d including such a cavity.

As illustrated in FIG. 10, a cavity 110 is provided on a top surface of the piston 100d. The second film 102 having a low heat conductivity and a high heat capacity is bonded in the cavity 110. The first film 101 having a low heat conductivity and a low heat capacity is bonded to the top surface of the piston 100d where the second film 102 is not provided.

During the ignition retardation operation immediately after the cold start of the internal combustion engine including such a piston, the fuel spray 20 is injected into the cavity 110, and the fuel liquid film 21 is formed on a surface of the cavity 110 as illustrated in FIG. 11. From the intermediate stage of the intake stroke to the intermediate stage of the compression stroke, since a surface temperature of the second film 102 having a low heat conductivity and a high heat capacity increases, the fuel liquid film 21 formed in the cavity 110 is heated and rapidly vaporized, so that emission of HC and PM can be reduced. During an operation of the cold engine, since most of the fuel liquid film 21 is formed within a bottom surface or a side surface of the cavity 110, vaporization of the fuel can be more effectively promoted if the second film 102 is formed on the bottom surface and the side surface of the cavity 110 as in the present embodiment.

On the other hand, during operation at normal ignition timing after warm-up of the engine, a cooling loss can be reduced by the temperature swing heat shielding with the first film 101 having a low heat conductivity and a low heat capacity that is provided outside the cavity 110.

Even when the second film 102 is provided not on the entire cavity 110 but on a portion thereof, an effect of reducing the emission of HC and PM can be obtained. The second film 102 is disposed only on a portion where most of fuel liquid film 21 is formed in the cavity 110, and the first film 101 is disposed on the remaining part in the cavity 110, whereby an effect of reducing a cooling loss by the first film 101 can be further increased while an effect of reducing HC and soot by the second film 102 is obtained.

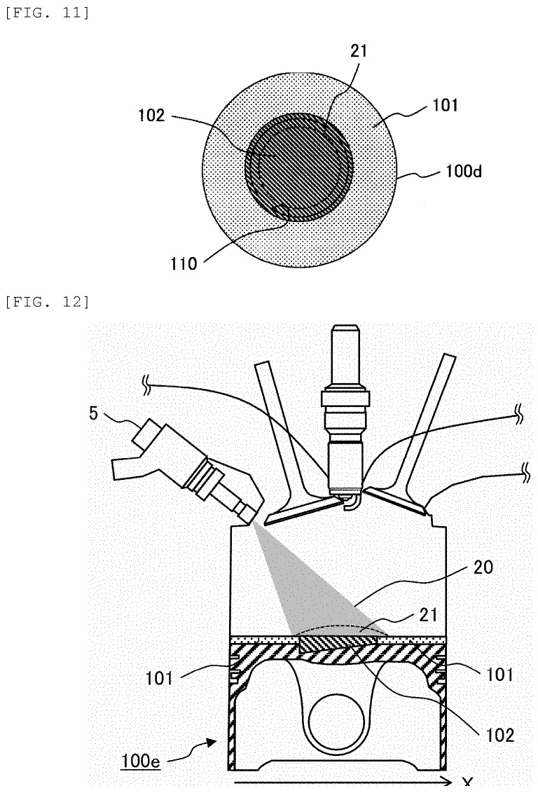

FIG. 12 is a longitudinal sectional view illustrating a fifth example of an internal combustion engine including a piston according to the invention. FIG. 13 is a graph showing a thickness of the liquid film of FIG. 12. As illustrated in FIG. 12, when the fuel spray 20 collides with a piston 100e to form the fuel liquid film 21 on a top surface of the piston, a thickness of the liquid film is distributed as shown in FIG. 13 with respect to a radial direction of a combustion chamber. That is, the thickness of the fuel liquid film 21 is greater near a nozzle tip end of the fuel injection valve 5, and is smaller away from the fuel injection valve. This is because, when a distance from the fuel injection valve 5 to the piston 100e is short, compared with a case where such a distance is long, deceleration time caused by air resistance of the fuel spray 20 is short, and the fuel spray 20 collides with the piston 100e at a relative higher speed. Since spatial dispersion of the fuel spray 20 is less as the distance is shorter, the fuel spray 20 collides with the piston 100e with a relative greater spray density, so that the thickness of the liquid film is greater.

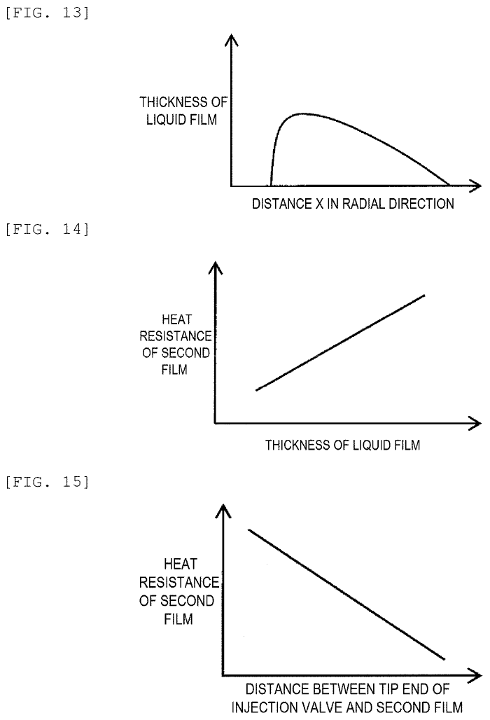

FIG. 14 is a graph showing a relationship between a heat resistance of the second film and the thickness of the liquid film. FIG. 15 is a graph showing a relationship between the heat resistance of the second film and a distance between the fuel injection valve and the second film. The time required for vaporization of the fuel liquid film 21 increases when the thickness thereof is increased, and therefore, it is desirable to apply more heat to the fuel liquid film 21 to promote the vaporization. Therefore, it is more preferable to change a film thickness of the second film according to the thickness of the fuel liquid film or an amount of the fuel liquid film formed on the top surface of the piston. Therefore, as shown in FIG. 14, a heat resistance R of the second film 102 at a portion where the thickness of the liquid film is greater a heat resistance R of the second film 102 at a portion where the thickness of the liquid film is smaller. The heat resistance R is defined by “a thickness of the second film 102/a heat conductivity of the second film 102”, so that the heat resistance R can be increased by increasing the thickness of the second film 102 or by reducing the heat conductivity of the second film 102. Alternatively, the thickness of the second film 102 may be increased and then the heat conductivity of the second film 102 may be reduced.

Since a surface temperature of the second film 102 can be higher as the heat resistance R is greater, a large amount of heat can be applied to the fuel liquid film 21 having a large thickness to shorten the time for vaporization. On the other hand, when the surface temperature of the second film 102 is too high, knocking may occur during a high-load operation of the engine, or air filling efficiency may decrease. Therefore, it is desirable that an area of a high-temperature portion of the top surface of the piston is as small as possible. The heat resistance R is changed according to the thickness of the fuel liquid film 21, so that repercussions for knocking and filling efficiency can be prevented while vaporization of the fuel liquid film 21 having the large thickness can be effectively promoted by using heat of the second film 102.

As described above, the thickness of the fuel liquid film 21 depends on a distance between the tip end of the fuel injection valve 5 and the fuel liquid film 21. Therefore, as shown in FIG. 15, the heat resistance R of the second film 102 may be increased as the distance between the tip end of the fuel injection valve 5 and the second film 102 is closer.

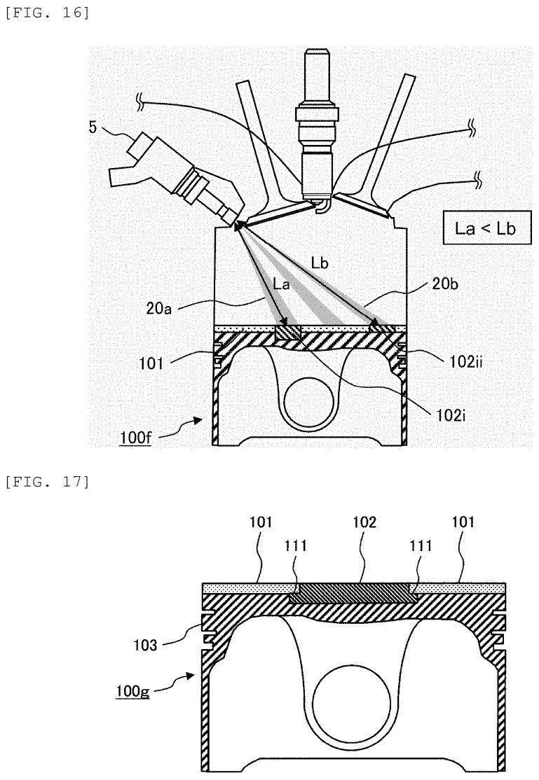

In a case where a plurality of second films 102 are provided, the heat resistance R respective second films 102 may be changed according to the distances between the tip end of the fuel injection valve 5 and the respective second films 102. FIG. 16 is a longitudinal sectional view illustrating a sixth example of an internal combustion engine including a piston according to the invention. In FIG. 16, a thickness of a second film 102i provided at a position close to a tip end of the fuel injection valve 5 is greater than a thickness of a second film 102ii provided at a position away from the tip end of the fuel injection valve 5. In addition, with the thicknesses of the second films 102i and 102ii being the same, a heat conductivity of the second film 102i provided at the position close to the tip end of the fuel injection valve 5 can be smaller than a heat conductivity of the second film 102ii provided at the position away from the tip end of the fuel injection valve 5. Accordingly, the heat resistance of the second film 102i in contact with a portion where the fuel liquid film 21 is formed thick can be increased, and vaporization of combustion can be promoted.

FIG. 17 is a longitudinal sectional view illustrating a seventh example of an internal combustion engine including a piston according to the invention. FIG. 18 is a longitudinal sectional view illustrating an eighth example of an internal combustion engine including a piston according to the invention. In the above-described configurations of the pistons, large portions of bottom surfaces of the first film 101 and the second film 102 are separately bonded to the base material 103. It should be noted that the first film 101 and the second film 102 may have portions that overlap each other in a thickness direction of the piston.

In a piston 100g of FIG. 17, a stepped portion 111 is provided at an end portion of the second film 102, and the first film 101 is disposed on the stepped portion 111. In a piston 100h of FIG. 18, an inclined portion 112 is provided at an end portion of the second film 102, and the first film 101 is disposed on the inclined portion 112. In both FIGS. 17 and 18, the first film 101 and the second film 102 do not overlap each other on a top surface of the piston, but the first film 101 and the second film 102 overlap each other in the thickness direction of the piston.

Accordingly, the second film 102 and the first film 101 are disposed to partially overlap each other, whereby adhesion between the second film 102 and the first film 101 is further enhanced, and the second film 102 and the first film 101 are less likely to be peeled off from the base material 103. The adhesion between the second film 102 and the first film 101 is increased, whereby fuel can be prevented from penetrating into a gap therebetween and thus emitted as HC.

When the second film 102 overlaps with an upper portion of the first film 101 (combustion chamber side) at an overlapped portion of the second film 102 and the first film 101, a heat resistance R of the overlapped portion is a sum of the heat resistance R₁₀₂ of the second film 102 and the heat resistance R₁₀₁ of the first film 101, and a heat capacity of a surface of the overlapped portion on the combustion chamber side increases. Therefore, a surface temperature of the overlapped portion may be locally high from the intake stroke to the compression stroke. Knocking and pre-ignition are caused by generation of such a local high temperature.

On the other hand, as in the above-described pistons 100g and 100h, when the first film 101 overlaps with an upper portion of the second film 102 at the overlapped portion of the second film 102 and the first film 101, the surface of the overlapped portion has a small heat capacity. Therefore, the surface temperature of the overlapped portion follows the gas temperature with a small temperature difference. Therefore, from the intake stroke to the compression stroke, the surface temperature of the overlapped portion is not locally increased, and knocking and pre-ignition can be prevented.

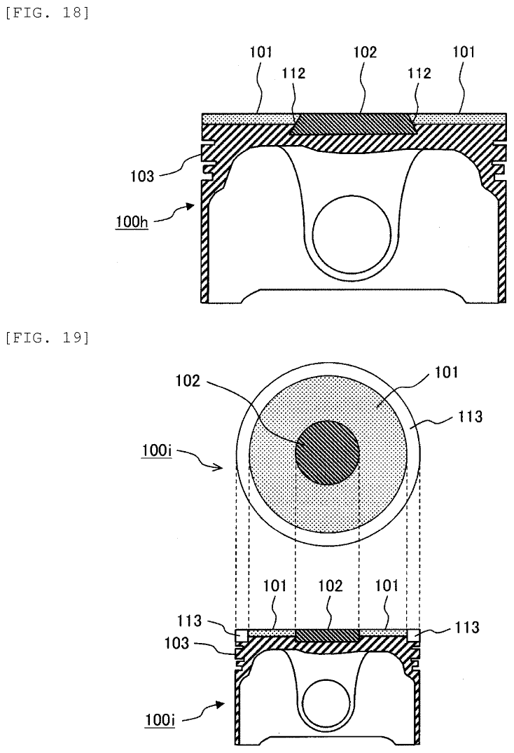

When a cooling loss is reduced by the temperature swing heat shielding method, heat of cooling is also reduced in the compression stroke. Therefore, a temperature of unburned gas in the vicinity of a compression top dead center increases, and knocking easily occurs. An embodiment for preventing this will be described with reference to FIG. 19.

FIG. 19 is a longitudinal sectional view illustrating a ninth example of an internal combustion engine including a piston according to the invention. On a surface of a piston 100i on the combustion chamber side illustrated in FIG. 19, in addition to the first film 101 and the second film 102, a cooling portion 113 is provided at an outer periphery of the piston. A heat conductivity of the cooling portion 113 is equal to or greater than that of the base material 103, and the entire or a large portion of a bottom surface of the cooling portion 113 is bonded to the base material 103.

Since the heat conductivity of the cooling portion 113 is equal to or greater than that of the base material of the piston, gas in an outer peripheral portion of the combustion chamber is selectively cooled by the cooling portion 113. Knocking is a phenomenon in which end gas in the outer peripheral portion of the combustion chamber is compressed by combustion and a temperature rises to cause self-ignition. Therefore, occurrence of the knocking can be prevented without significantly impairing an effect of reducing a cooling loss with the temperature swing heat shielding method by selectively cooling the gas in the outer peripheral portion of the combustion chamber with the cooling portion 113.

FIG. 20 is a longitudinal sectional view illustrating a tenth example of an internal combustion engine including a piston according to the invention. In FIG. 20, the cooling portion 113 is formed of the base material 103 itself. As illustrated in FIG. 20, the base material 103 is exposed to a piston surface of an outer peripheral portion of the combustion chamber to form the cooling portion 113.

(2.2) Structure of Surface Layer

Next, an example of the configuration of the first film 101 and the second film 102 (hereinafter, both are collectively referred to as a surface layer) suitable for the piston according to the invention will be described in detail. FIG. 25 is a sectional view schematically illustrating the surface layer (the first film and the second film). As illustrated in FIG. 25, a surface layer 300 includes a parent phase 130 and hollow particles 134 dispersed in the parent phase 130. The hollow particle 134 is a particle having pores 135 therein. The parent phase 130 has a metal phase 136 in which a plurality of metal particles are bonded, and a void 137. The hollow particles 134 are contained in the void 137.

A volume ratio of the voids 137 contained in the parent phase 130 and the pores 135 contained in the hollow particles 134 to the surface layer 300 is referred to as “porosity”. A heat conductivity and a volumetric specific heat of the surface layer 300 can be reduced by increasing the porosity.

Since the second film 102 has a large heat capacity with respect to the first film 101, porosity of the second film 102 is smaller than that of the first film 101. The porosity of the second film is preferably set as, for example, about 20%. On the other hand, the first film 101 preferably has a porosity of, for example, about 50% in order to have a low heat conductivity and a low volumetric specific heat.

The surface layer 300 is required to have high adhesion to the base material 103 and high tensile strength in order to withstand a harsh environment (high temperature, high pressure, and high vibration) in the internal combustion engine. A large portion of the parent phase 130, which constitutes a major portion of the surface layer 300 serving as a porous body, is set as the metal phase 136, whereby high adhesion and high durability between the base material 103 formed of metal and the surface layer 300 can be obtained. The hollow particles 134 are contained in the voids 137 of the parent phase 130, and the voids 137 in the parent phase 130 are combined with the pores 135 of the hollow particles 134, whereby a volume of the voids 137 in the parent phase 130 is suppressed to keep strength of the surface layer 300 high while a porosity necessary for lowering a heat conductivity is ensured.

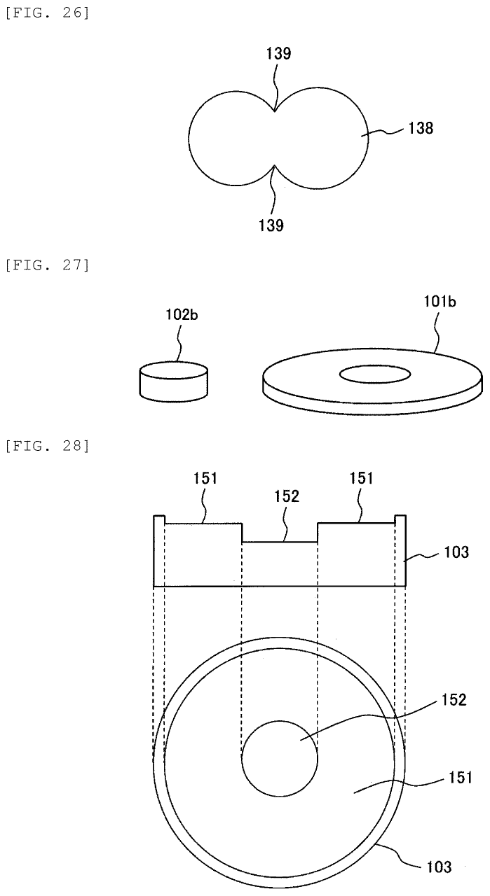

FIG. 26 is an enlarged schematic view of a metal particle that constitutes the metal phase 136 of FIG. 25. The metal phase 136 is preferably formed of a sintered metal in which the metal particles are bonded by sintering. As illustrated in FIG. 26, it is preferable that a part of metal particles 138 are bonded to each other by sintering to have necks 139. A space between the metal particles can be ensured by the necks 139 to form the void 137. A sintering density is controlled, so that a ratio of the voids 137 can be controlled, and a heat conductivity, a volumetric specific heat, and a strength of the surface layer 300 can be variously changed.

The metal phase 136 and the base material 103 preferably contain the same metal as a main component thereof. Specifically, it is preferable that the base material 103 is formed of an aluminum (Al) alloy, and the metal phase 136 is formed of Al. As described above, the base material 103 and the metal phase 136 that constitutes the major portion of the surface layer 300 contain the same metal, so that a strong solid-phase bonding portion is formed at an interface between the base material 103 and a surface phase 300 having a porous structure to ensure high adhesion, and the surface layer 300 excellent in durability can be achieved.

As a raw material of the hollow particle 134, in order to ensure a heat insulation performance of the surface layer 300, it is preferable to use a material having a low heat conductivity and a high strength even if the particle is hollow. Examples of such a material include silica, alumina, and zirconia and the like. Examples of the hollow particle containing silica as a main component include ceramic beads, silica aerogel, and porous glass and the like.

### 3. Method of Manufacturing Piston for Internal Combustion Engine

Next, an example of the method of manufacturing the piston according to the invention will be described.

(3.1) Preparation of First Film and Second Film

When the first film and the second film are manufactured, first, the metal particles 138 serving as a raw material of the metal phase 136 and a powder of the hollow particles 134 are mixed, and the mixed particles are heated to obtain sintered bodies. As a sintering method, pressure sintering capable of controlling a load and a temperature during sintering is preferable, and a pulsed electric current sintering method is preferable. In this method, a pulse is electrified while a powder of a raw material is pressurized. Resistance heat and heat caused by spark discharge are generated on a powder surface, and reaction on the powder surface is activated, so that the necks 139 are easily formed at contact portions between the metal particles. Therefore, in the pulsed electric current sintering method, the metal particles can be firmly bonded at the neck 139 even in a porous sintered body including a large number of voids.

During the sintering, when an applied pressure is increased, porosity of the sintered body decreases; and when the applied pressure is decreased, the porosity of the sintered body increases. Therefore, when the first film 101 having a low heat conductivity and a low volumetric specific heat is formed, a ratio of the hollow particles 134 in the powder of the raw material is increased, and the applied pressure is low during the sintering. On the other hand, when the second film 102 having a low heat conductivity and a high volumetric specific heat is formed, the ratio of the hollow particles 134 in the powder of raw material is decreased, and the applied pressure is high during the sintering.

FIG. 27 is a view schematically illustrating the first film and the second film obtained by forming the sintered bodies. As illustrated in FIG. 27, the sintered bodies obtained in the above-described sintering step are molded into predetermined thicknesses and shapes, so as to obtain a base sintered body 101b for the first film 101 and a base sintered body 102b for the second film 102.

(3.2) Preparation of Base Material

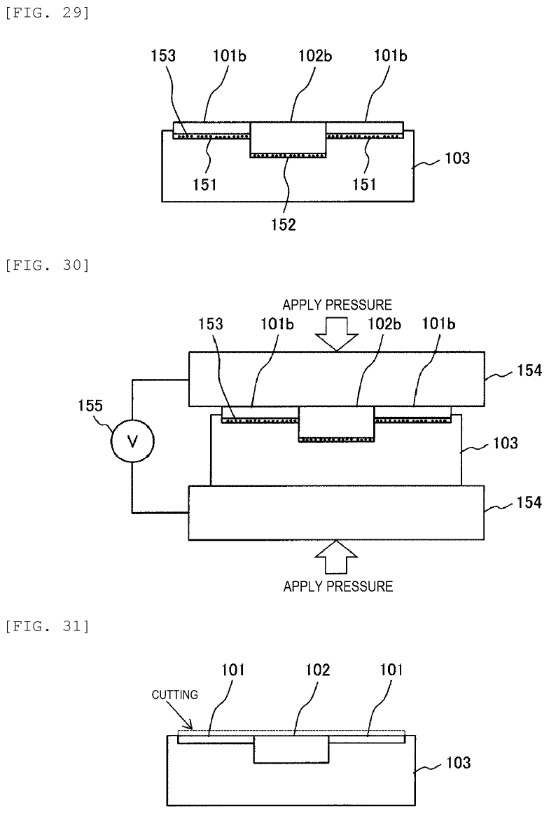

FIG. 28 is a sectional view and a plan view of an example of the base material. The base material 103 is manufactured by casting an aluminum alloy or the like. The base material 103 is machined to form, as illustrated in FIG. 28, a recess 151 for disposing the base sintered body 101b, and a recess 152 for disposing the base sintered body 102b, on a surface of the base material 103 on the combustion chamber side.

(3.3) Bonding of Base Material with First Film and Second Film

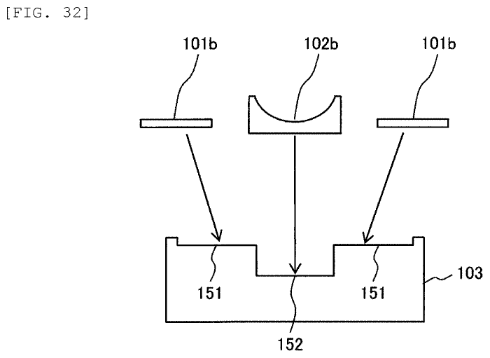

FIG. 29 is a sectional view illustrating a state in which the base sintered bodies are disposed on the surface of the base material. FIG. 30 is a schematic view illustrating an apparatus for bonding the base sintered bodies to the base material in FIG. 29. As illustrated in FIG. 29, the base sintered body 101b is fitted into the recess 151, and the base sintered body 102b is fitted into the recess 152. At this time, an insert material 153 having a melting point lower than that of any of the base material 103, and the base sintered bodies 101b, 102b is disposed between the base material 103 and the base sintered bodies 101b and 102b. As illustrated in FIG. 30, the base sintered bodies 101b, 102b are pressure-adhered to the base material 103 by electrodes 154 that are pulse-electrified by a power source 155. Then, the insert material 153 is heated and melted, and diffused into the base sintered bodies 101b, 102b. As a result, the base sintered bodies 101b, 102b are bonded to the base material 103 by so-called diffusion bonding. The pulsed electric current method for bonding the base sintered bodies 101b, 102b to the base material 103 is used, whereby the base sintered bodies 101b, 102b having a large number of voids can be firmly bonded to the base material 103. According to the above-described method of manufacturing the piston, the first film 101 and the second film 102 having different heat conductivities, volumetric specific heats, and thicknesses are simultaneously bonded to the base material 103, so that a manufacturing process of the piston can be simplified and the cost can be reduced.

(3.4) Forming of Top Surface of Piston

FIG. 31 is a sectional view schematically illustrating forming (machining) of the top surface of the piston. As illustrated in FIG. 31, the top surface of the piston is formed by machining such that surfaces of the base sintered bodies 101b, 102b and the base material 103 are at the same height (the top surface of the piston is flat).

FIG. 32 is a sectional view schematically illustrating another example of the base material and the base sintered bodies. As illustrated in FIG. 32, the base sintered bodies 101b, 102b are formed in advance to coincide with a final shape of a piston surface, and then bonded to the base material 103 by the above-described method, whereby machining after bonding the base sintered bodies 101b, 102b to the base material 103 is not necessary, and man-hours for manufacturing a piston can be reduced.

FIG. 32 shows an example in which a cavity is formed in advance on a surface of the base sintered body 102b of the second film 102 to bond the base sintered body 102b to the base 103. As a result, a piston with the cavity is formed without performing machining after bonding.

The base sintered bodies 101b, 102b can also be formed into final shapes while the sintered bodies 101b, 102b and the base material 103 are sintered. Specifically, during the sintering, powders of raw materials of the sintered bodies are placed in a mold in accordance with a shape of the completed piston, and pulsed electric current sintering is performed while a pressure is applied. The base sintered bodies 101b, 102b can be formed into final shapes without machining by performing the sintering and forming in this manner, so that manufacturing man-hours can be reduced.

According to the above-described invention, it is possible to provide a piston for an internal combustion engine in which heat efficiency can be improved while emissions is kept low, and the temperature of the piston can be prevented from being excessively high so that the occurrence of knocking and pre-ignition and decrease in air filling efficiency is prevented, and to provide a method of manufacturing the piston for the internal combustion engine. That is, by using the first film 101 having a low heat conductivity and a low heat capacity, a cooling loss can be reduced by a temperature swing heat shielding method, so that fuel efficiency of an engine can be improved. On the other hand, by using the second film 102 having a low heat conductivity and a high heat capacity, vaporization of the fuel liquid film 21 formed on a piston surface is promoted, so that HC and PM can be reduced.

The invention is not limited to the embodiments described above, and includes various modifications. For example, the above-described embodiments are described in detail for easy understanding of the invention, and the invention is not necessarily limited to those including all the configurations described above. Further, a part of the configuration of one embodiment can be replaced with the configuration of another embodiment, and the configuration of another embodiment can be added to the configuration of one embodiment. For a part of the configurations of the individual embodiments, other configurations can be added, removed, or replaced.

### REFERENCE SIGN LIST

1 intake port
2 exhaust port
3 intake valve
4 exhaust valve
5 fuel injection valve
6 ignition plug
7 engine head
8 cylinder
9 combustion chamber
5 fuel injection valve
20 fuel spray
21 fuel liquid film
100a, 100b, 100c, 100d, 100e, 100f, 100g, 100f, 100g, 100h, 100i, 100′ piston
101 first film (heat shielding film)
101b base sintered body of first film
101′ anodic oxide coating
102, 102i, 102ii second film (heat insulating film)
102′ metal coating
102b base sintered body of second film
103, 103′ base material
104 bottom surface of first film
105 bottom surface of second film
110 cavity
111 stepped portion
112 inclined portion
113 cooling portion
130 parent phase
134 hollow particle
135 pore
136 metal phase
137 void
138 metal particle
139 neck
151, 152 recess
153 insert material
154 electrode
155 power supply
200 internal combustion engine
300 surface layer

1. A piston for an internal combustion engine, the piston constituting a part of a combustion chamber of the internal combustion engine, the piston for the internal combustion engine comprising:
a base material;
a first film provided on a portion of a top surface of the base material in contact with the combustion chamber; and
a second film provided on another portion of the top surface, wherein
the first film has a heat conductivity and a heat capacity smaller than those of the base material, and the second film has a heat conductivity smaller than that of the base material, and a heat capacity greater than that of the first film.

2. The piston for the internal combustion engine according to claim 1, wherein
the first film and the second film are disposed in parallel when the piston is viewed from above.

3. The piston for the internal combustion engine according to claim 1, wherein
a recess is provided on a surface of the base material, and the second film is disposed on a bottom surface or a side surface of the recess, or on both the bottom surface and the side surface of the recess.

4. The piston for the internal combustion engine according to claim 1, wherein
the second film is disposed at a portion to which fuel sprayed from a fuel injection valve included in the internal combustion engine adheres, on a top surface of the piston.

5. The piston for the internal combustion engine according to claim 4, wherein
on the top surface of the piston, a heat resistance of the second film increases as an adhesion amount of the fuel increases or as a thickness of a fuel liquid film formed by the fuel adhering to the top surface of the piston increases.

6. The piston for the internal combustion engine according to claim 4, wherein
on the top surface of the piston, the heat resistance of the second film increases as a distance between the second film and the fuel injection valve decreases.

7. The piston for the internal combustion engine according to claim 1, wherein
the first film and the second film have a portion where the first film and the second film overlap with each other in a depth direction of the piston, and
the first film is located on the second film in the portion where the first film and the second film overlap.

8. The piston for the internal combustion engine according to claim 1, wherein
a cooling portion having a heat conductivity equal to or greater than that of the base material is provided on a portion of a top surface of the piston where the first film and the second film are not disposed.

9. The piston for the internal combustion engine according to claim 8, wherein
the cooling portion is formed of a part of the base material.

10. The piston for the internal combustion engine according to claim 9, wherein
the cooling portion is disposed on an outer peripheral portion of the piston.

11. The piston for the internal combustion engine according to claim 1, wherein
the first film has a volumetric specific heat of 500 kJ/m³K or less, a heat conductivity of 0.5 W/mK or less, and a film thickness of 50 to 200 μm, and the second film has a volumetric specific heat of 1000 kJ/m³K or more, a heat conductivity of 1 to 10 W/mK and a film thickness of 200 μm or more.

12. The piston for the internal combustion engine according to claim 1, wherein
the first film and the second film separately have a parent phase and a hollow particle that has a pore inside, the parent phase has a metal phase in which a plurality of metal particles are bonded and a void, and the hollow particle is contained in the void.

13. The piston for the internal combustion engine according to claim 1, wherein
a plurality of second films are disposed on the top surface of the piston, and a sum of surface areas of the plurality of second films on a combustion chamber side is smaller than a surface area of the first film on the combustion chamber side.

14. A method of manufacturing a piston for an internal combustion engine, the piston constituting a part of an inner wall surface of a combustion chamber of the internal combustion engine, the method of manufacturing the piston for the internal combustion engine comprising:
a step of preparing a base material;
a step of preparing a first film having a heat conductivity and a heat capacity smaller than those of the base material, and a second film having a heat conductivity smaller than that of the base material and a heat capacity greater than that of the first film;
a step of preparing an insert material having a melting point lower than that of the base material, that of the first film, and that of the second film;
a step of disposing the first film and the second film on a surface of the base material with the insert material being sandwiched; and
a bonding step of heating the insert material to bond the first film and the second film to the base material.

15. The method of manufacturing the piston for the internal combustion engine according to claim 14, wherein
in the step of preparing the first film and the second film, a raw material of the first film and a raw material of the second film are sintered by a pulsed electric current sintering method to obtain sintered bodies.

16. The method of manufacturing the piston for the internal combustion engine according to claim 14, wherein
in the bonding step, a method of heating the insert material is a pulsed electric current method.

17. The method of manufacturing the piston for the internal combustion engine according to claim 14, further comprising:
a step of disposing a recess in which the first film is fittable and a recess in which the second film is fittable on the surface of the base material.

18. The method of manufacturing the piston for the internal combustion engine according to claim 14, wherein
in the step of preparing the first film and the second film, surfaces of the first film and the second film on a combustion chamber side are sintered and formed to coincide with a shape of a top surface of the piston after manufacture.

19. The method of manufacturing the piston for the internal combustion engine according to claim 14, wherein
in the step of preparing the first film and the second film, surfaces of the first film and the second film on a combustion chamber side are machined to coincide with a shape of a top surface of the piston after manufacture.

20. The method of manufacturing the piston for the internal combustion engine according to claim 14, wherein
in the step of preparing the first film and the second film, powders of raw materials of the first film and the second film are placed in a mold that coincides with a shape of the piston after manufacture, and
in the step of disposing the first film and the second film, the mold is disposed on the surface of the base material.
